(19) United States
(12) Patent Application Publication
(10) Pub. No.: US 2026/0242061 A1
(43) Pub. Date: Aug. 20, 2026

(54) AIRCRAFT PASSENGER SEATS WITH SOUND IMMERSIVE SYSTEMS

(71) Applicant: Safran Seats USA LLC, Gainesville, TX (US)

(72) Inventors: Mario Gerardo Herrera Murillo, Moissy-Cramayel (FR); Juan Francisco Lopez Chavira, Moissy-Cramayel (FR)

(73) Assignee: Safran Seats USA LLC, Gainesville, TX (US)

(21) Appl. No.: 19/161,265

(22) PCT Filed: Mar. 31, 2023
(86) PCT No.: PCT/US2023/017069

§ 371 Date: Aug. 31, 2025

(51) Int. Cl. B64D 11/00; B64D 11/06

(52) U.S. Cl. CPC B64D 11/0015; B64D 11/06; B64D 2011/0053

(57) ABSTRACT

An aircraft passenger seat includes a seat back, a seat base, and a cushion on at least one of the seat back or the seat base. The aircraft passenger seat also includes a sound immersive entertainment system that includes at least one exciter that is integrated into the cushion and configured to generate mechanical vibrations in the passenger seat.

### FIELD OF THE INVENTION

The field of the invention relates to passenger seats for vehicles, and, more particularly, to aircraft passenger seats with sound immersive systems.

### BACKGROUND

Passenger vehicles, such as airplanes, automobiles, and the like often include entertainment systems for providing an enhanced passenger experience, particularly so in first class seats and business class seats. Such entertainment systems may include a monitor and/or audio output (e.g., headset) providing entertainment such as movies, television shows, musical compositions, games, etc. However, existing entertainment systems may not provide a high-quality listening experience and/or may affect other passengers on board the passenger vehicle.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a passenger seat for an aircraft includes a seat back, a seat base, a cushion on at least one of the seat back or the seat base, and an entertainment system with at least one exciter integrated into the cushion. The exciter may generate mechanical vibrations in the passenger seat.

In some embodiments, the entertainment system includes an audio output, and the entertainment system may align sound signal frequency of the audio output with mechanical vibration frequency of the at least one exciter.

In various embodiments, the at least one exciter includes a mass and a suspension such that movement of the mass is transmitted to the passenger seat.

In certain embodiments, the entertainment system includes at least one entertainment device, and a characteristic of the entertainment device is controlled based on the exciter. In some cases, the at least one entertainment device may include a light associated with the passenger seat, and the characteristic may include at least one of a light intensity, a light frequency, a light color, a light pattern, or an activation status of the light.

In some examples, the entertainment system includes a controller that controls an intensity of the mechanical vibration and/or a frequency of the mechanical vibration. Optionally, the controller includes a user interface for receiving input from a user for controlling the exciter.

In various aspects, the seat back comprises a headrest, and the at least one exciter is integrated in the headrest.

In certain aspects, the at least one exciter is integrated in the seat back.

In some cases, the at least one exciter is integrated in the seat base.

In certain embodiments, the at least one exciter includes a plurality of exciters. Optionally, at least one exciter is integrated in the seat back and at least one exciter is integrated in the seat base. Optionally the passenger seat includes a leg rest, and optionally at least one exciter of the plurality of exciters is integrated in a cushion of the leg rest.

The passenger seat may include a seat shell at least partially surrounding the passenger seat and at least one light on the seat shell, and at least one characteristic of the at least one light may be controlled based on the at least one exciter.

In some embodiments, the at least one exciter includes a plurality of exciters. An intensity or frequency of each exciter of the plurality of exciters may be independently adjustable and/or jointly adjustable as desired.

In certain embodiments, the entertainment system is a headset-free entertainment system.

According to certain embodiments of the present invention, a passenger seat assembly for an aircraft includes a passenger seat with at least one cushion, a seat shell at least partially surrounding the passenger seat, and an entertainment system with an entertainment device on the seat shell and an exciter integrated in the at least one cushion. The exciter may generate mechanical vibrations in the passenger seat, and at least one characteristic of the entertainment device may be controlled based on the exciter.

In some embodiments, the entertainment device is a light, and the exciter may generate the mechanical vibrations in alignment with a sound signal frequency.

According to certain embodiments of the present invention, a passenger seat assembly for an aircraft includes a passenger seat having at least one cushion, a cabin light associated with the passenger seat, and an entertainment system with an exciter integrated in the at least one cushion. The exciter may generate mechanical vibrations in the passenger seat, and at least one characteristic of the cabin light may be controlled based on the exciter.

In various embodiments, the at least one cushion is a first cushion of a plurality of cushions, and the exciter is a first exciter of a plurality of exciters integrated into the plurality of cushions.

In certain embodiments, the entertainment system includes an audio output for emitting sound signals, and the entertainment system may control mechanical vibrations of the exciter to align with the sound signals.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 illustrates a passenger seat with an entertainment system according to certain embodiments of the present invention.

FIGS. 2A-B illustrate exciters of the entertainment system of FIG. 1.

FIGS. 3A-B illustrate the passenger seat of FIG. 1 with an entertainment device of the entertainment having a first characteristic.

FIGS. 4A-B illustrate the passenger seat of FIG. 1 with an entertainment device of the entertainment having a second characteristic.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide entertainment systems of a passenger vehicle. While the entertainment systems are discussed for use with aircraft as passenger vehicles, they are by no means so limited. Rather, embodiments of the entertainment systems may be used in passenger vehicles of any type or otherwise as desired.

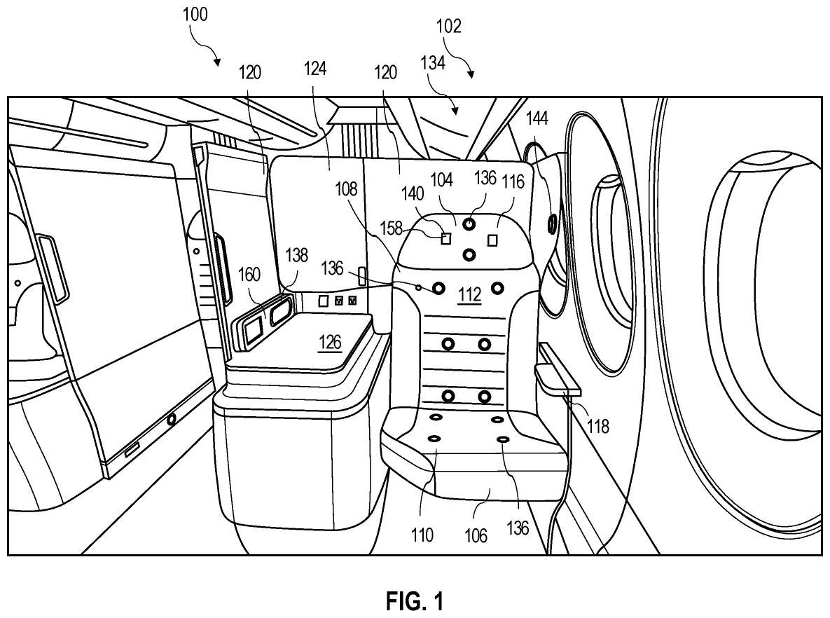

FIG. 1 illustrates a portion of a passenger vehicle 100 such as an aircraft according to embodiments of the disclosure. As illustrated, one or more passenger seat assemblies 102 may be provided within the passenger vehicle 100.

Each passenger seat assembly 102 generally includes a passenger seat 104 having a seat base 106 and a seat back 108. The seat base 106 includes one or more cushions and defines a base surface 110. The seat back 108 similarly includes one or more cushions and defines a back surface 112. In use, a passenger may contact the base surface 110 and the back surface 112. In certain embodiments, the seat back 108 is movable relative to the seat base 106 such that the passenger seat 104 can be in various configurations, such as but not limited to a taxiing, takeoff, and landing configuration as illustrated in FIG. 1, a reclined configuration (e.g., the seat back 108 extends at an oblique angle relative to the seat back 108), and/or a lie-flat or bed configuration in which the base surface 110 and the back surface 112 are generally horizontal.

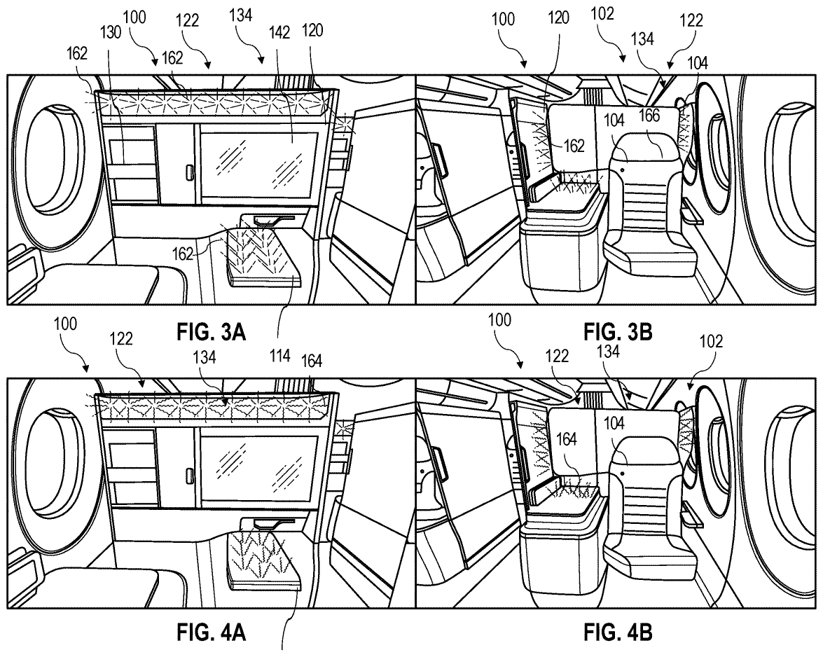

Optionally, the passenger seat 104 includes a footrest assembly 114, although it need not in other embodiments. In certain embodiments, the footrest assembly 114 may be at least partially defined by the seat shell 122 as illustrated in FIGS. 3A and 4A. Optionally, the footrest assembly 114 may partially define a bed surface for the passenger (together with the surfaces 110, 112) when the passenger seat 104 is in the lie flat configuration.

Optionally, the passenger seat 104 includes a headrest 116 supported on the seat back 108. When included, the headrest 116 may be movable and/or adjustable relative to the seat back 108. As non-limiting examples, the headrest 116 may be tiltable, foldable, slidable, pivotable, and/or otherwise movable as desired such that the headrest 116 may be provided at a desired configuration relative to the seat back 108.

Optionally, the passenger seat 104 includes an armrest 118. In certain embodiments, the armrest 118 optionally may be defined by a portion of a wall 120 of a seat shell 122 that at least partially surrounds the passenger seat 104.

As illustrated in FIGS. 1 and 3A-B, the seat shell 122 may be included with the passenger seat 104 and may at least partially surround the passenger seat 104. In such embodiments, the seat shell 122 may define a living space that the passenger may utilize during travel. In certain embodiments, the seat shell 122 includes a sound dampening material such that the seat shell 122 provides passive noise cancelling for the passenger utilizing the passenger seat 104. However, in other embodiments, other materials may be utilized for the seat shell 122 as desired. As illustrated, the seat shell 122 may include one or more of the walls 120, stowage compartments 124, a table surface 126, a door, and/or a literature pocket 130.

In certain embodiments, the passenger seat 104 includes an associated entertainment system 134. The entertainment system 134 includes one or more exciters 136 for generating mechanical vibrations in the passenger seat 104 as discussed in detail below. The entertainment system 134 may also include a controller 138 and optionally one or more audio outputs 140. Optionally, the entertainment system 134 may include one or more monitors 142 and/or one or more entertainment devices 144.

The one or more exciters 136 are integrated into the cushions of the passenger seat 104 at various locations as desired. In the embodiment illustrated in FIG. 1, the exciters 136 are integrated into the headrest 116, the seat base 106, and the seat back 108. In the example illustrated in FIG. 1, the passenger seat 104 includes twelve exciters 136-two exciters 136 on the headrest 116, six exciters 136 on the seat back 108, and four exciters 136 on the seat base 106. However, the number of exciters 136 should not be considered limiting. Moreover, the one or more exciters 136 may be provided in various patterns or arrangements on the passenger seat 104 as desired. As non-limiting examples, the exciters 136 may be integrated in locations on the cushion that align with portions of a passenger when the passenger is utilizing the passenger seat 104 and/or surrounding portions of a passenger when the passenger is utilizing the passenger seat 104. In the embodiment of FIG. 1, the exciters 136 on the seat base 106 are at locations that may align with legs of the passenger, the exciters 136 on the seat back 108 are at locations that may align with a back of the passenger, and the exciters 136 on the headrest 116 are at a location that may surround a head of the passenger. Various other patterns and/or configurations of exciters 136 may be utilized as desired, and the arrangement illustrated in FIG. 1 should not be considered limiting.

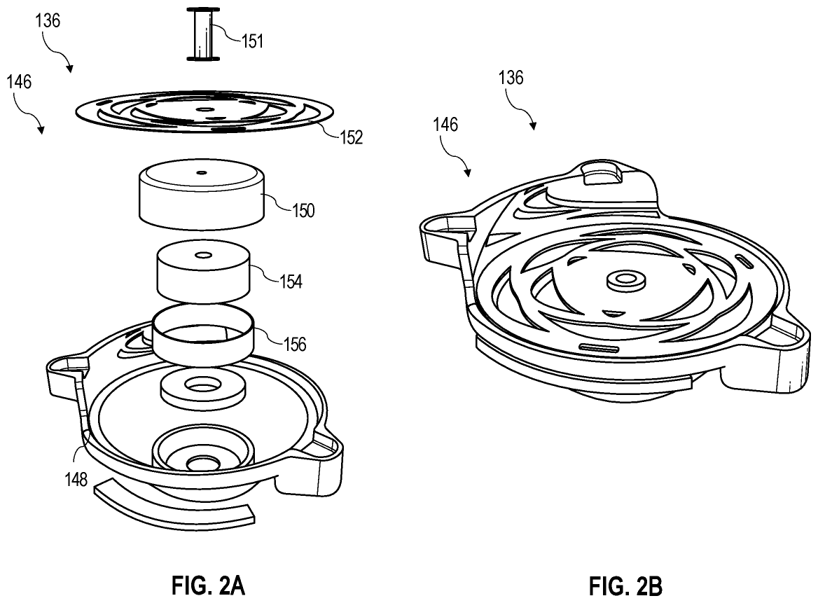

The one or more exciters 136 may be various suitable devices or mechanisms for generating mechanical vibrations in the passenger seat 104. As a non-limiting example, the exciter 136 may be a sound transducer such as but not limited to a mechanical-type sound transducer such as but not limited to the mechanical-type sound transducer illustrated in FIGS. 2A-B. As illustrated in FIGS. 2A-B, in such embodiments, the sound transducer 146 may include components such as but not limited to a housing 148, a moving mass 150, a suspension 152 for the moving mass 150, a stator 154, and a voice coil 156. A fastener 151 or other suitable device or mechanism may be used to couple one or more components of the sound transducer 146. In such embodiments, the sound transducer 146 may convert electrical energy into mechanical energy, e.g., by causing movement of the moving mass 150. As a further non-limiting example, the exciter 136 may be other types of mechanical-type sound transducers and/or other types of sound transducers, such as but not limited to a diaphragm-type sound transducer. Various other types of devices suitable for generating mechanical vibrations may be utilized as the one or more exciters 136 as desired, and the above examples should not be considered limiting.

In embodiments with a plurality of exciters 136, the type of exciter 136 may be controlled, and at least one exciter 136 optionally may be different from another exciter 136, although they need not be in other embodiments. In certain embodiments, the type of a particular exciter 136 utilized may be controlled based on a location of the exciter 136 on the passenger seat 104 (e.g., on the headrest 116 vs. on the seat base 106 vs. on the seat back 108 vs. on the footrest assembly 114) and/or a shape of the cushions. Optionally, and as illustrated in FIGS. 3B and 4B, a dress cover 166 may be provided on the passenger seat 104, and the dress cover 166 may cover the exciters 136. In other embodiments, the dress cover 166 may be omitted.

While the one or more exciters 136 generate mechanical vibrations, the one or more audio outputs 140 may provide auditory or sound output. In the embodiment illustrated, the audio output 140 includes one or more speakers 158 that are integrated into the headrest 116. In other embodiments, the one or more speakers 158 may be provided at other locations on the passenger seat 104, such as but not limited to the seat base 106, the seat back 108, the seat shell 122, combinations thereof, and/or other locations as desired. In such embodiments, the entertainment system 134 may be a headset-free entertainment system. Additionally, or alternatively, the one or more audio outputs 140 may include an interface (e.g., an audio jack) enabling the use of headphones with the entertainment system 134. In certain embodiments and as discussed in detail below, the auditory output from the audio outputs 140 may be controlled with the exciters 136 to provide an enhanced entertainment experience to the passenger of the passenger seat 104.

The one or more entertainment devices 144 may provide supplemental entertainment and/or features to provide an enhanced entertainment experience. In some examples, the one or more entertainment devices 144 may include light sources, supplemental speakers, supplemental monitors, combinations thereof, and/or other entertainment devices as desired. In the embodiment illustrated, the one or more entertainment devices 144 include light sources provided at various locations on the seat shell 122. As discussed in detail below, one or more characteristics of the light sources and/or other entertainment devices (e.g., color, pattern, frequency, intensity, location, etc.) may be controlled with the exciters 136 to provide an enhanced entertainment experience to the passenger of the passenger seat 104.

The controller 138 of the entertainment system 134 may be communicatively coupled (e.g., via wired or wireless communication) to the one or more exciters 136 and may control one or more characteristics of the exciters 136. As non-limiting examples, the controller 138 may control an activation status (e.g., on or off) of one or more exciters 136, a frequency of the mechanical vibrations from the one or more exciters 136, an intensity of the mechanical vibrations of the one or more exciters 136, combinations thereof, and/or other characteristics as desired to provide desired haptic feedback and an improved immersive entertainment experience. Optionally, the controller 138 includes a user interface 160 with mechanical and/or virtual buttons or features that a passenger may utilize to control one or more characteristics of the one or more exciters 136.

The controller 138 optionally may be communicatively coupled to the one or more audio outputs 140, the one or more entertainment devices 144, and/or the one or more monitors 142 and such that the controller 138 may control one or more characteristics of the audio outputs 140, entertainment devices 144, and/or the monitors 142. In some embodiments, the controller 138 may align and/or otherwise control the mechanical vibrations of the one or more exciters 136 with characteristics of the audio outputs 140, entertainment devices 144, and/or the monitors 142. As a non-limiting example, the controller 138 may control the sound signal frequency and/or intensity from the audio outputs 140 to align with the mechanical vibration frequency and/or intensity from the exciters 136.

Referring to FIGS. 3A-B and 4A-B, in another non-limiting example, the controller 138 may control a light color and/or light pattern based on the mechanical vibration frequency and/or intensity from the exciters 136. FIGS. 3A-B illustrate the light sources as entertainment devices 144 having a first color or pattern (represented by straight lines 162) based on a first mechanical vibration frequency and/or intensity, and FIGS. 4A-B illustrate the light sources as entertainment devices 144 having a second color or pattern (represented by wavy lines 164) based on a second mechanical vibration or frequency. The controller 138 may provide various other control of the exciters 136 and/or one or more of the audio outputs 140, entertainment devices 144, and/or monitors 142 as desired, and the above examples should not be considered limiting.

As mentioned, the above control may provide desired haptic feedback to a particular passenger to provide an improved immersive entertainment experience where the passenger may both hear and feel sound of entertainment (e.g., rhythms of music, voices and sound effects of movies or television series, desired sound, or musical compositions, etc.). Various other benefits and advantages may be realized with the systems and methods described herein, and the above benefits and advantages should not be considered limiting.

A collection of exemplary embodiments is provided below, including at least some explicitly enumerated as an “Example” providing additional description of a variety of example embodiments in accordance with the concepts described herein. These examples are not meant to be mutually exclusive, exhaustive, or restrictive; and the disclosure not limited to these examples but rather encompasses all possible modifications and variations within the scope of the issued claims and their equivalents.

Example 1. A passenger seat for an aircraft, the passenger seat comprising: a seat back; a seat base; a cushion on at least one of the seat back or the seat base; and an entertainment system comprising at least one exciter integrated into the cushion, the exciter configured to generate mechanical vibrations in the passenger seat.

Example 2. The passenger seat of any of the preceding or subsequent examples or combination of examples, wherein the entertainment system further comprises an audio output, and wherein the entertainment system is configured to align sound signal frequency of the audio output with mechanical vibration frequency of the at least one exciter.

Example 3. The passenger seat of any of the preceding or subsequent examples or combination of examples, wherein the at least one exciter comprises a mass and a suspension such that movement of the mass is transmitted to the passenger seat.

Example 4. The passenger seat of any of the preceding or subsequent examples or combination of examples, wherein the entertainment system further comprises at least one entertainment device, and wherein a characteristic of the entertainment device is controlled based on the exciter.

Example 5. The passenger seat of any of the preceding or subsequent examples or combination of examples, wherein the at least one entertainment device comprises a light associated with the passenger seat, and wherein the characteristic comprises at least one of a light intensity, a light frequency, a light color, a light pattern, or an activation status of the light.

Example 6. The passenger seat of any of the preceding or subsequent examples or combination of examples, wherein the entertainment system comprises a controller, wherein the controller is configured to control an intensity of the mechanical vibration or a frequency of the mechanical vibration.

Example 7. The passenger seat of any of the preceding or subsequent examples or combination of examples, wherein the controller comprises a user interface configured to receive input from a user for controlling the exciter.

Example 8. The passenger seat of any of the preceding or subsequent examples or combination of examples, wherein the seat back comprises a headrest, and wherein the at least one exciter is integrated in the headrest.

Example 9. The passenger seat of any of the preceding or subsequent examples or combination of examples, wherein the at least one exciter is integrated in the seat back.

Example 10. The passenger seat of any of the preceding or subsequent examples or combination of examples, wherein the at least one exciter is integrated in the seat base.

Example 11. The passenger seat of any of the preceding or subsequent examples or combination of examples, wherein the at least one exciter comprises a plurality of exciters, and wherein at least one exciter is integrated in the seat back and at least one exciter is integrated in the seat base.

Example 12. The passenger seat of any of the preceding or subsequent examples or combination of examples, wherein the at least one exciter comprises a plurality of exciters, wherein the passenger seat comprises a leg rest, and wherein at least one exciter of the plurality of exciters is integrated in a cushion of the leg rest.

Example 13. The passenger seat of any of the preceding or subsequent examples or combination of examples, further comprising a seat shell at least partially surrounding the passenger seat and at least one light on the seat shell, wherein at least one characteristic of the at least one light is controlled based on the at least one exciter.

Example 14. The passenger seat of any of the preceding or subsequent examples or combination of examples, wherein the at least one exciter comprises a plurality of exciters, and wherein an intensity or frequency of each exciter of the plurality of exciters is independently adjustable.

Example 15. The passenger seat of any of the preceding or subsequent examples or combination of examples, wherein the entertainment system is a headset-free entertainment system.

Example 16. A passenger seat assembly for an aircraft, the passenger seat assembly comprising: a passenger seat comprising at least one cushion; a seat shell at least partially surrounding the passenger seat; and an entertainment system comprising an entertainment device on the seat shell and an exciter integrated in the at least one cushion, wherein the exciter is configured to generate mechanical vibrations in the passenger seat, and wherein at least one characteristic of the entertainment device is controlled based on the exciter.

Example 17. The passenger seat assembly of any of the preceding or subsequent examples or combination of examples, wherein the entertainment device is a light, and wherein the exciter is configured to generate the mechanical vibrations in alignment with a sound signal frequency.

Example 18. A passenger seat assembly for an aircraft, the passenger seat assembly comprising: a passenger seat comprising at least one cushion; a cabin light associated with the passenger seat; and an entertainment system comprising an exciter integrated in the at least one cushion, wherein the exciter is configured to generate mechanical vibrations in the passenger seat, and wherein at least one characteristic of the cabin light is controlled based on the exciter.

Example 19. The passenger seat assembly of any of the preceding or subsequent examples or combination of examples, wherein the at least one cushion is a first cushion of a plurality of cushions, and wherein the exciter is a first exciter of a plurality of exciters integrated into the plurality of cushions.

Example 20. The passenger seat assembly of any of the preceding or subsequent examples or combination of examples, wherein the entertainment system further comprises an audio output for emitting sound signals, and wherein the entertainment system is configured to control mechanical vibrations of the exciter to align with the sound signals.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the FIG. (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A passenger seat for an aircraft, the passenger seat comprising:
a seat back;
a seat base;
a cushion on at least one of the seat back or the seat base; and
an entertainment system comprising:
at least one of a monitor or an audio output providing an entertainment experience to a passenger of the passenger seat;
at least one exciter integrated into the cushion, the exciter configured to generate mechanical vibrations in the passenger seat; and
a controller configured to control the at least one exciter based on the entertainment information provided by the monitor and/or the audio output.

2. The passenger seat of claim 1, wherein the controller is configured to align sound signal frequency of the audio output with mechanical vibration frequency of the at least one exciter.

3. The passenger seat of claim 1, wherein the at least one exciter comprises a mass and a suspension such that movement of the mass is transmitted to the passenger seat.

4. The passenger seat of claim 1, wherein the entertainment system further comprises at least one supplemental entertainment device, and wherein the controller is configured to control a characteristic of the supplemental entertainment device is controlled based on the exciter.

5. The passenger seat of claim 4, wherein the at least one supplemental entertainment device comprises a light associated with the passenger seat, and wherein the characteristic comprises at least one of a light intensity, a light frequency, a light color, a light pattern, or an activation status of the light.

6. The passenger seat of claim 1, wherein the controller is configured to control an intensity of the mechanical vibration or a frequency of the mechanical vibration based on the entertainment information provided by the monitor and/or the audio output.

7. The passenger seat of claim 6, wherein the controller comprises a user interface configured to receive input from a user for controlling the exciter.

8. The passenger seat of claim 1, wherein the seat back comprises a headrest, and wherein the at least one exciter is integrated in the headrest.

9. The passenger seat of claim 1, wherein the at least one exciter is integrated in the seat back.

10. The passenger seat of claim 1, wherein the at least one exciter is integrated in the seat base.

11. The passenger seat of claim 1, wherein the at least one exciter comprises a plurality of exciters, and wherein at least one exciter is integrated in the seat back and at least one exciter is integrated in the seat base.

12. The passenger seat of claim 1, wherein the at least one exciter comprises a plurality of exciters, wherein the passenger seat comprises a leg rest, and wherein at least one exciter of the plurality of exciters is integrated in a cushion of the leg rest.

13. The passenger seat of claim 1, further comprising a seat shell at least partially surrounding the passenger seat and at least one light on the seat shell, wherein at least one characteristic of the at least one light is controlled based on the at least one exciter.

14. The passenger seat of claim 1, wherein the at least one exciter comprises a plurality of exciters, and wherein an intensity or frequency of each exciter of the plurality of exciters is independently adjustable.

15. The passenger seat of claim 1, wherein the entertainment system is a headset-free entertainment system.

16. A passenger seat assembly for an aircraft, the passenger seat assembly comprising:
a passenger seat comprising at least one cushion;
a seat shell defining a living space within the aircraft, wherein the passenger seat is positioned within the living space and such that the seat shell at least partially surrounding the passenger seat; and
an entertainment system comprising:
at least one of a monitor or a speaker configured to provide entertainment information to a passenger of the passenger seat;
a cabin light on the seat shell;
an exciter integrated in the at least one cushion, wherein the exciter is configured to generate mechanical vibrations in the passenger seat; and
a controller configured to (i) control at least one characteristic of the cabin light based on the entertainment information and (ii) control the mechanical vibrations of the exciter based on the entertainment information.

17. The passenger seat assembly of claim 16, wherein wherein the exciter is configured to generate the mechanical vibrations in alignment with a sound signal frequency.

18. A passenger seat assembly for an aircraft, the passenger seat assembly comprising:
a passenger seat comprising at least one cushion;
a cabin light associated with the passenger seat; and
an entertainment system comprising:
at least one of a monitor or a speaker configured to provide entertainment information to a passenger of the passenger seat;
an exciter integrated in the at least one cushion, wherein the exciter is configured to generate mechanical vibrations in the passenger seat; and
a controller configured to (i) control the mechanical vibrations of the exciter based on the entertainment information and (ii) control at least one characteristic of the cabin light is controlled based on the control of the exciter.

19. The passenger seat assembly of claim 18, wherein the at least one cushion is a first cushion of a plurality of cushions, and wherein the exciter is a first exciter of a plurality of exciters integrated into the plurality of cushions.

20. The passenger seat assembly of claim 18, wherein the entertainment system further comprises an audio output for emitting sound signals, and wherein the entertainment system is configured to control mechanical vibrations of the exciter to align with the sound signals.
